(19) United States
(12) Patent Application Publication
(10) Pub. No.: US 2003/0185221 A1
(43) Pub. Date: Oct. 2, 2003

(54) Network controller with shadowing of software routing tables to hardware routing tables

(76) Inventors: Alan Deikman, Fremont, CA (US); Robert A. Miller, Santa Barbara, CA (US)

Correspondence Address: BEVER HOFFMAN & HARMS, LLP, TRI-VALLEY OFFICE, 1432 CONCANNON BLVD., BLDG. G, LIVERMORE, CA, 94550, US

(21) Appl. No.: 10/113,829

(22) Filed: Mar. 29, 2002

(51) Int. Cl. H04L 12/28; H04J 3/16

(52) U.S. Cl. 370/401; 370/466

(57) ABSTRACT

A method and system is provided for using a hardware switch fabric with software configured for a software switch. The method and system provides the speed of a hardware switch fabric with the flexibility and ease of use of standard software switches. Specifically, the network controller includes a software routing table for the software switch and a hardware routing table for the hardware switch. A shadowing daemon detects changes in the software routing table and copies the changes to the hardware routing table.

### BACKGROUND OF THE INVENTION

1. Field of the Invention

The present invention relates to computer networking. More specifically, the present invention relates to methods and systems for high-speed network switching and routing.

2. Discussion of Related Art

Computer networks have been used for many years for small data transfers and simple communications, such as email. In recent years, the amount of network traffic on computer networks of all levels has greatly increased with the increase of digital data, such as digital audio and video files. Typically, computers on a network share a common network medium. The network medium can only sustain a limited amount of network traffic before network congestion degrades network performance to an unacceptable level.

On large computer networks, network congestion is relieved by segmenting the network into different network segments. FIG. 1 shows how a typical computer network 100 is segmented using a network controller 110, such as a network switch (also known as a network “bridge”) or a network router. Specifically, in network 100, network controller 110 divides computer network 100 into network segments 120, 130, 140, 150 and 160. Rather than sending all data packets to all network segments, network controller 110 only sends relevant data packets to each network segment. Relevant data packets refer to data packets addressed to one or more network devices, such as computers, network storage devices, or other network controllers, in a network segment. For example, if computer 121 on network segment 120 sends a data packet to computer 141 on network segment 140, network controller 110 only propagates the data packet from network segment 120 to network segment 140. Thus, network segments 130, 150, and 160 are not congested with irrelevant data packets. In addition, to relieving network congestion, network controllers also offer other benefits such as connecting different types of networks together. For example, network controllers are often used to connect networks using fiber optics network medium with networks using copper network medium.

Network switching generally occurs at layer 2, i.e. the data transport layer, while network routing occurs at layer 3, i.e., the network layer. Thus, network controller 110 must be aware of the media access addresses (MAC addresses) of the network devices on each network segment for network switching. For network routing, network controller 110 must be aware of the Layer 3 network address of each device on each network segment.

To define which computers on various network segments must be addressed using layer 2 versus layer 3 methods, the concept of a Virtual Local Area Network (VLAN) is used. For example, in network 100 a VLAN 170 includes two network segments 150 and 140 and a VLAN 180 includes Network segments 120, 130, 140, and 160. If a Network segment is a member of more than one VLAN, each data packet must be tagged with a VLAN tag to indicate which VLAN it is a member of. VLAN tags are optional on Network segments that are a member of only one VLAN. If packets are not tagged, they are assigned to the VLAN that corresponds with the interface on the Network Controller 110. If a data packet is to be sent from one computer to another computer on the same VLAN, layer 2 addressing is used. If the destination computer is on a different VLAN than the sending computer, layer 3 addressing is used.

FIG. 2 shows a simplified block diagram of a software based network controller 200. Simplified block diagrams are used for clarity, one skilled in the art can adapt the techniques illustrated and explained with the simplified block diagrams to design, build and use actual network controllers. Network controller 200 includes a microprocessor 210, a memory system 220, a memory bus 230, a peripheral bus 240, and network interfaces 251, 252, 253, 254 and 255. Each network interface is attached to a different network segment. The number of network interfaces can vary considerably between different network controllers. For example, some network controllers may have as few as two network interfaces while others may have dozens of network interfaces. Common network interfaces include Ethernet, Token Ring, E1/T1 Interfaces, ATM, and others. Each of the interfaces may be running at different speeds appropriate to that interface type. For example, Ethernet is standardized to run at 10, 100, or 1,000 megabits per second, in addition to other speeds. Microprocessor 210 is coupled to memory system 220 by memory bus 230. Microprocessor 210 is coupled to network interfaces 251-255 by peripheral bus 240, which could be for example a PCI bus.

Microprocessor 210 generally runs a version of a network operating system (not shown), such as Unix, Windows, or Linux, which resides in memory system 220. Furthermore, microprocessor 210 is configured by software in memory system 220 to perform the network switching and/or routing functions. Specifically, memory system 220 includes network software 222, a software routing table 224, a software switch 226, low-level network interface device drivers (NIDDs) 227_1 to 227_5, a protocol stack 228, and high-level network interface device drivers (NIDDs) 229_1 to 229_5. Low-level network interface device drivers 227_1-227_5 corresponds with network interfaces 251-255, respectively. Similarly, high-level network interface device drivers 229_1-229_5 corresponds with network interfaces 251-255, respectively. Protocol stack 228 includes the elements required for the other software elements running in the microprocessor to send and receive data packets from any of the network interfaces 251-255 through high-level NIDDs 229_ to 229_5. Software switch 226 controls where data packets are transferred onto the various network segments that are coupled to network interfaces 251-255. The actions of software switch 226 are controlled by software routing table 224 on a packet-by-packet basis. Software switches, software routing tables, protocol stacks, and NIDDs are well known in the art and are not discussed in detail.

Network software 222 controls and updates the network information in software routing table 224. Many instances of network software 222 may co-exist in memory system 220. Each instance of network software 222 can operate using either Layer 2 or Layer 3. Layer 2 network software controls data packets using low-level network interface device drivers 227_1-227_5, while layer 3 network software controls data packets using high-level network interface device drivers 229_1-229_5. Specifically, layer 2 network software sends or receives data packets from one of the network segments by invoking one of the low-level network interface device drivers. By selecting a specific low-level network interface device driver, layer 2 network software can control which of the corresponding network interfaces is used for the send or receive operation. Layer 3 network software sends or receives data packets from one of the network segments by invoking the protocol stack (usually as a subroutine) with a parameter (a number, a symbol, or pointer) that indicates which high-level network interface driver to use. By selecting a specific high-level network interface device driver, network software 222 can control which of the corresponding network interfaces is used for the send or receive operation.

Network software is well known in the art and therefore not discussed in detail. For example, gated (“gate D”) and routed (“route D”) are two well-known implementations of network software 222 that manipulate software routing table 224 automatically according to industry standard protocols. Other instances of network software 222 are user-interface commands that are used interactively to manipulate software routing table 224. Furthermore, other high level network software may be added to increase flexibility and functionality to network controller 200. For example, web load balancing, firewalls, virtual private networking (VPN), voice on internet protocol (VoIP), multimedia multicasting, are all well known functions provided by high-level network software that can be used with network controller 200.

The primary advantage of software based network controllers is ease of use and flexibility because network software can be easily modified. Furthermore, many open source implementations of various types of network software are freely available. Thus, software based network controllers can be quickly implemented and customized. However, the speed of software based network controllers are limited by microprocessor 210 and peripheral bus 240. Typically, software based network controllers can only process a few hundred thousand data packets per second. In contrast, a single 1,000 megabit per second Ethernet link may handle more than a million data packets per second. Thus for large networks, software based network controllers may not be fast enough to significantly reduce network congestion.

FIG. 3 is a simplified block diagram of a network controller 300 using a hardware switch fabric 330. Network controller 300 includes microprocessor 210, memory system 220, memory bus 230, peripheral bus 240, a hardware routing table 320, a hardware switch fabric 330, and network interfaces 251-255. Hardware switch fabric 330 and hardware routing table 320 are coupled to microprocessor 210 by peripheral bus 240. In addition, hardware switch fabric 330 can access hardware routing table 320 via a switch fabric bus 340. Hardware switch fabric 330 is coupled to and configured to control network interfaces 251-255. Specifically, hardware switch fabric 330 controls whether data packets are transferred onto various network segments that are coupled to network interfaces 251-255. Hardware routing table 320 controls the actions of hardware switch fabric 330. Generally, hardware switch fabric 330 is an integrated circuit that is designed and manufactured to work with hardware routing table 320 which may be integrated or supplied on a separate silicon device. Furthermore, each manufacturer creates a custom interface for hardware routing table 320. Thus, microprocessor 210 is configured with custom network software 322, which resides in memory system 220 and communicates to network interfaces 251-255 via a custom protocol stack 324 and hardware switch fabric device driver (HSFDD) 326. Custom network software 322 controls and updates hardware routing table 320 although in some implementations some modifications to the hardware routing table 320 may be performed by hardware switch fabric 330. Hardware switch fabrics and hardware routing tables are well known in the art and are not discussed in detail.

The advantage of using a hardware switch fabric is the increased speed provided by dedicated hardware. For example, a typical hardware switch fabric can process the maximum number of packets per second allowed by the standards for which the network interfaces were designed. For example, a hardware switch fabric designed to interface to eight 1,000 megabit per second Ethernet ports may handle more than 12 million data packets per second. Thus, network controllers using hardware switch fabrics can usually handle any amount of data traffic that is possible on the network segments to which it is attached. However, network controllers using hardware switch fabrics are more difficult to build and maintain because each hardware switch fabric requires custom silicon and software to be developed. Hence, there is a need for a network controller that can provide the speed of a hardware switch fabrics and the flexibility and ease of use of software switches.

### SUMMARY

Accordingly, the present invention provides a method and system for allowing existing network software designed to be used with a software switch to be used with a hardware switch fabric without requiring modification of the existing network software. The network software continues to interface with the software switch and the software routing table as in conventional systems. However, in one embodiment of the present invention a shadowing daemon copies changes in the software routing table to the hardware routing table. Some embodiment of the shadowing daemon translate the change in the software routing table into a hardware routing table format. In another embodiment of the present invention, a snooping daemon detects instructions that change the software routing table and then applies the instructions to the hardware routing table. Some embodiments of the snooping daemon may translate the instruction to a hardware routing table format.

Network controllers in accordance with embodiments of the present invention generally include a microprocessor, a memory system coupled to the microprocessor by a memory bus, and a hardware switch fabric coupled to the microprocessor by a peripheral bus. When using a hardware switch fabric, the network interfaces are generally coupled to the hardware switch fabric rather than the peripheral bus. Conventional network interface device drivers are not able to communicate with the network interfaces unless the network interfaces are on the peripheral bus. Thus, some embodiments of the present invention include low-level pseudo network interface device drivers, which allow network software to control the network interfaces. Each low-level pseudo network interface device driver is a hardware switch fabric device driver that is configured to operate a specific network interface.

Some embodiments of the present invention also allow high-level network software to use the hardware switch fabric. These embodiments of the present invention include a protocol stack and high-level pseudo network interface device drivers. High-level network software is able to control network interfaces using the protocol stack and the high-level pseudo network interface device drivers. Each high-level pseudo network interface device driver is a hardware switch fabric device driver that is configured to operate a specific network interface.

Some embodiments of the present invention are designed to operate in an environment with virtual local area networks (VLANs). In these embodiments, a VLAN device driver is included for each VLAN. A VLAN device driver interfaces with the protocol stack and the hardware switch fabric. Specifically, a VLAN device driver is a hardware switch fabric device driver that is configured to communicate with a specific VLAN.

The present invention will be more fully understood in view of the following description and drawings.

### BRIEF DESCRIPTION OF THE DRAWINGS

FIG. 1 is block diagram of a computer network using a network controller with two virtual local area networks (VLANs).

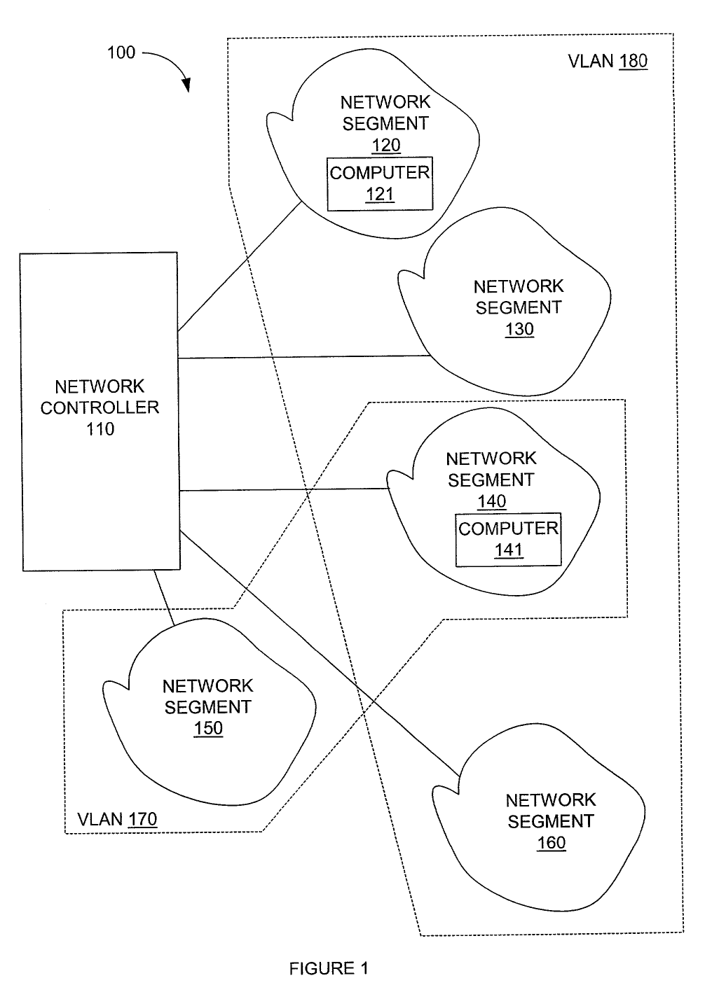

FIG. 2 is a block diagram of a network controller using a software switch.

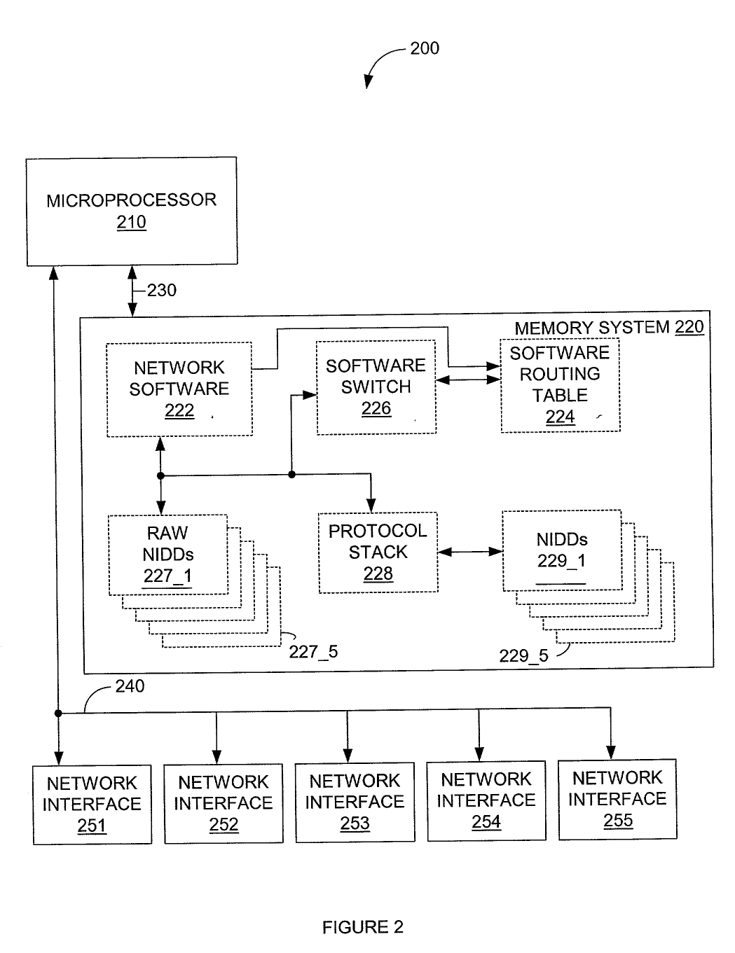

FIG. 3 is a block diagram of a network controller using a hardware switch fabric.

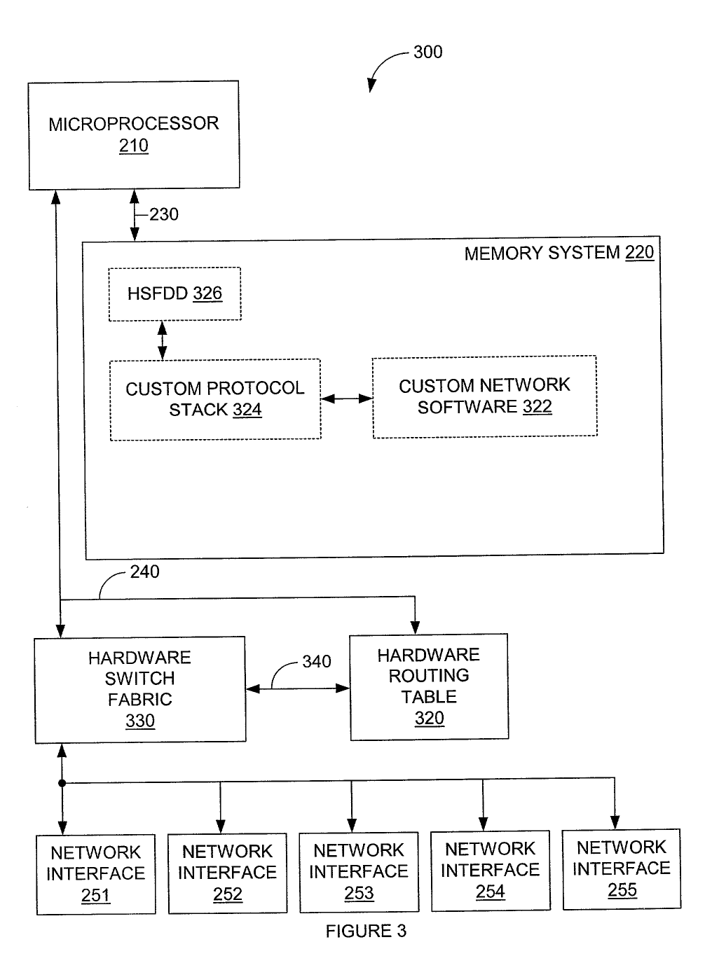

FIG. 4 is a block diagram of a network controller using a shadowing daemon in accordance with one embodiment of the present invention.

FIGS. 5(a) and 5(b) are block diagrams of a low-level network interface device driver and a low-level pseudo network interface device driver, respectively.

FIGS. 6(a) and 6(b) are block diagrams of a high-level network interface device driver and a high-level pseudo network interface device driver, respectively.

FIG. 7 is a block diagram of a network controller using VLAN device drivers in accordance with one embodiment of the present invention.

FIG. 8 is a block diagram of a network controller using low-level pseudo network interface device drivers, high-level pseudo network interface device drivers, and VLAN drivers in accordance with one embodiment of the present invention.

### DETAILED DESCRIPTION

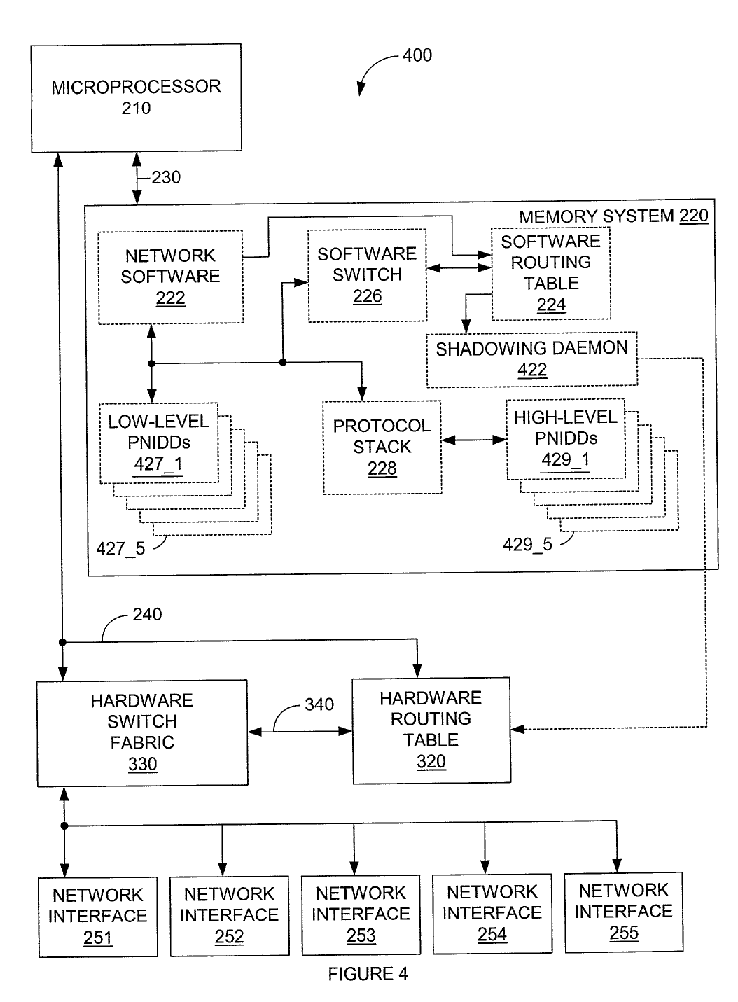

As explained above, network traffic for large networks may be too great for a network controller using a software switch. Network controllers using hardware switch fabrics are capable of handling the network traffic of large networks; however, network controllers using hardware switch fabrics require custom network software, which takes time to develop. FIG. 4 is a block diagram of a network controller 400 in accordance with one embodiment of the present invention. Network controller 400 combines the flexibility and ease of use of a software switch with the speed of a hardware switch fabric.

Network controller 400 includes microprocessor 210, memory system 220, memory bus 230, peripheral bus 240, hardware routing table 320, hardware switch fabric 330, and network interfaces 251-255. To provide the flexibility and ease of use of network controllers using software switches, network controller 400 replicates the same software interface used in network controller 200 so that network software 222 can be used without modification in network controller 400. Thus, microprocessor 210 in network controller 400 also runs a version of a network operating system such as Unix, Windows, or Linux. Furthermore, microprocessor 210 can be configured using most of the same software as used in network controller 200, which uses software switch 226 to manage the network interfaces. Thus, memory system 220 includes network software 222, software routing table 224, software switch 226, and protocol stack 228. However, low-level network interface device drivers 227_1-227_5 are replaced with low-level pseudo network interface device drivers (PNIDDs) 427_1-429_5. Similarly, high-level network interface device drivers 229_1-229_5 are replaced with high-level pseudo network interface device drivers (PNIDDs) 429_1-429_2. The distinction between network interface device drivers and pseudo network interface device drivers is described below. In addition, network controller includes a shadowing daemon 422, which is also described below.

In operation, data packets may be switched either with hardware switch fabric 330 or software switch 226. During operation, incoming data packets may have addresses unknown to hardware routing table 320, in which case they are sent to software switch 226 or network software 222 to determine their proper disposition. Software switch 226 will respond by forwarding the data packet as appropriate, and network software 222 may respond by making alterations in the software routing table 224. Network software 222 and software routing table 224 can be exactly the same in network controller 400 and network controller 200. Thus, existing software used in network controller 200 can be used with network controller 400 without modification.

For fast switching speed, network controller 400 includes hardware switch fabric 330, which is coupled to and configured to control network interfaces 251-255. As explained above, hardware switch fabric 330 controls whether data packets are transferred onto various network segments that are coupled to network interfaces 251-255. Hardware routing table 320 controls the actions of hardware switch fabric 330. Shadowing daemon 422 is configured to copy any changes in the network information in software routing table 224 into hardware routing table 320. In addition, shadowing daemon 422 performs whatever rule translations that are needed convert the information from software routing table 224 to the form used by hardware routing table 320, which controls the action of hardware switch fabric 330. Any changes to software routing table 224 by network software 222 in effect controls the operation of hardware switch fabric 330. Thus, shadowing daemon 422 transparently copies changes in software routing table 224. In one embodiment of the present invention, shadowing daemon 422 monitors software routing table 224 for changes. If a change is detected, shadowing daemon 422 implements the corresponding changes in hardware routing table 320. In another embodiment of the present invention, shadowing daemon 422 monitors instructions to software routing table 224. When an instruction to change software routing table 224 is detected, shadowing daemon makes the corresponding changes in hardware routing table 320. In these embodiments, the shadowing daemon may be referred to as a snooping daemon. Generally, shadowing daemon 422 is customized to work with hardware routing table 320. Different hardware routing tables usually require a different version of shadowing daemon 422. Generally, shadowing daemon 422 can be provided by the manufacturer of hardware switch fabric 330 or by a third party vendor. Thus, the developers of network controller 400 do not need to spend time or resources to learn and use the interface for hardware routing table 320.

Even though existing network software can be used with network controller 400, custom network software may be developed for network controller 400. However, development time for the custom network software for network controller 400 is greatly reduced because the custom network software is programmed to use a well-known interface, i.e. software routing table 224 rather than a custom interface for hardware routing table 320.

In a specific embodiment of network controller 400, microprocessor 210 is a Motorola XPC8240, which uses a custom memory bus for the memory bus 230. The memory system 220 is a 64-megabyte subsystem built from common SDRAM parts. Peripheral bus 240 is the industry-standard PCI bus. Hardware switch fabric 330 is the Broadcom BCM5600 series product, which has twenty-four 10/100 megabit Ethernet interfaces and two 1000 megabit Ethernet interfaces.

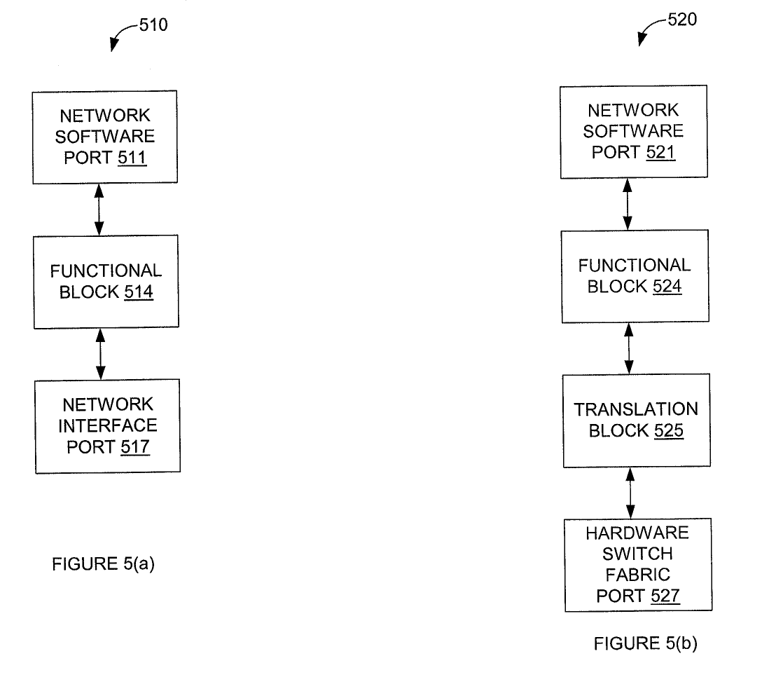

As explained above, to allow unmodified versions of network software 222 to function in network controller 400, low-level network interface device drivers 227_1-227_5 and high-level network interface device drivers 229_1-220_2 are replaced with low-level pseudo network interface device drivers 427_1-427_5 and high-level pseudo network interface device drivers 429_1-429_5, respectively. FIGS. 5(a) and 5(b) shows the pertinent differences between a low-level network interface device driver 510 and a low-level pseudo network interface device driver 520. As shown in FIG. 5(a), low-level network interface device driver 510 includes a network software port 511, a functional block 514, and a network interface port 517. Network software port 511 allows network software 222 to use low-level network interface device driver 510. Functional block 514 represents the functional elements used by network software 222 to control a network interface. Network interface port 517 provides the communication protocols to actually communicate with a network interface on the peripheral bus.

However, in network controller 400, network interfaces 251-255 are not located on peripheral bus 240. Thus, software in memory system 220 cannot directly control network interfaces 251-255. Rather, software in memory system 220 must indirectly control network interfaces 251-255 by using hardware switch fabric 330. Thus, low-level pseudo network interface device drivers are configured to interface with hardware switch fabric 330 rather than directly with a network interface. As shown in FIG. 5(b), a low-level pseudo network interface device driver 520 includes network software port 521, functional block 524, a translation block 525, and hardware switch fabric port 527. To maintain compatibility with network software 222, network software port 521 duplicates the functionality of network software port 511. In many embodiments of the present invention, network software port 521 appears to be identical to network software port 511. Functional block 524 represents the functional elements used by network software 222 to control a network interface. In some embodiments of the present invention, functional block 524 is identical to functional block 514. Translation block 525 translates the commands for a network interface into analogous commands to hardware switch fabric 330 (FIG. 4). Then, the commands are provided to hardware switch fabric 330 through hardware switch fabric port 527. Thus, a low-level pseudo network interface device driver is actually a hardware switch fabric device driver configured to operate a specific network interface. However, compatibility is retained with network software 222. Therefore, network software 222 can control network interfaces that are not directly coupled to peripheral bus 240.

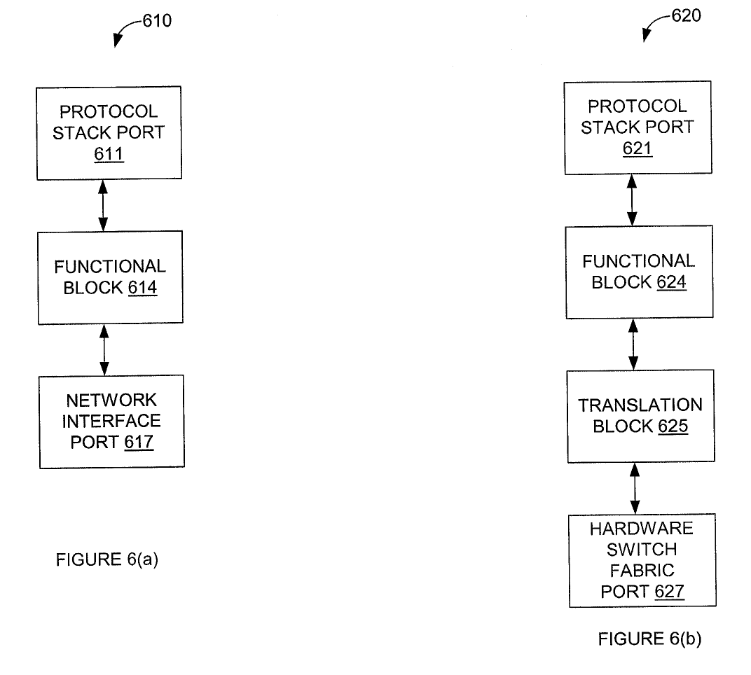

FIGS. 6(a) and 6(b) shows the pertinent differences between a high-level network interface device driver 610 and a high-level pseudo network interface device driver 620. As shown in FIG. 6(a), high-level network interface device driver 610 includes a protocol stack port 611, a functional block 614, and a network interface port 617. Protocol stack port 511 interfaces with protocol stack 228 (FIG. 4) to allows network software 222 to use high-level network interface device driver 610. Functional block 614 represents the functional elements used by network software 222 and protocol stack 228 to control a network interface. Network interface port 617 provides the communication protocols to actually communicate with a network interface on the peripheral bus.

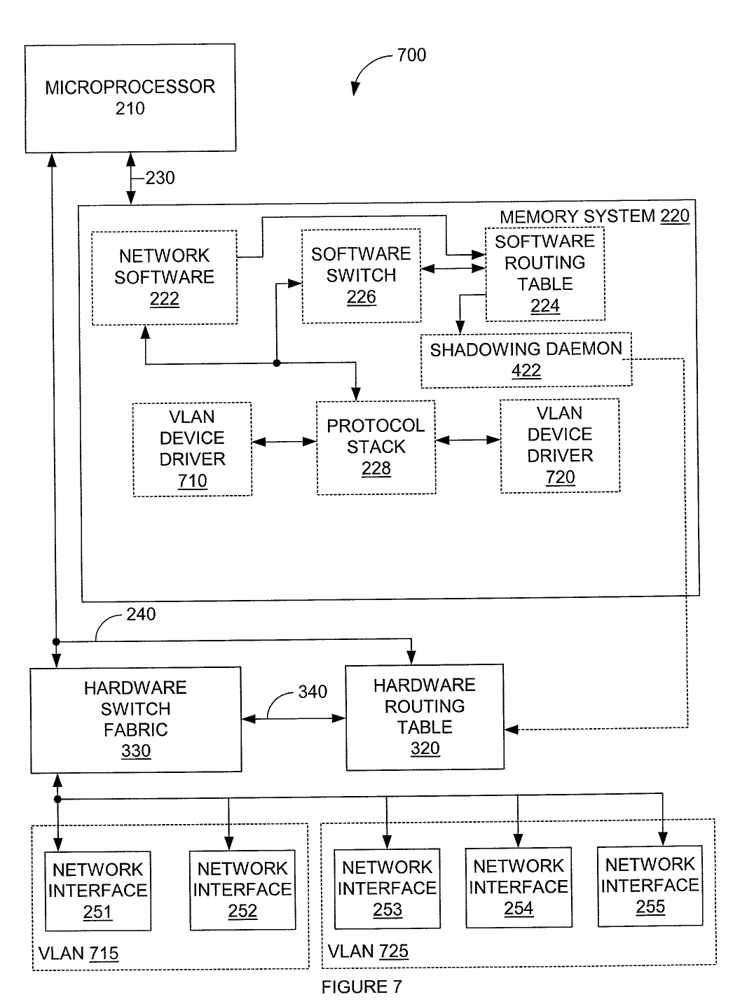

In addition to providing network interface drivers for each network interface, some embodiments of the invention also provide device drivers for VLANS. In general, a VLAN device driver is provided for each VLAN. For example, a network controller 700, as shown in FIG. 7 includes a VLAN device driver 710 for VLAN 715, which includes network interface 251 and 252. Network controller 700 also includes a VLAN Driver 720 for VLAN 725, which includes network interfaces 253, 254, and 255. Although not shown, network controller 700 may also include low-level pseudo network interface device drivers and high-level pseudo network device drivers. As described above, a VLAN may contain one or more network segments, and any network segment may belong to one or more VLANs. Network software 222 may select any of the VLAN using the corresponding VLAN device driver to send and receive data packets to and from the corresponding VLANs. In actual implementation, VLAN device drivers 710 and 720 are device drivers for hardware switch fabric 330 that are configured to communicate with a specific VLAN.

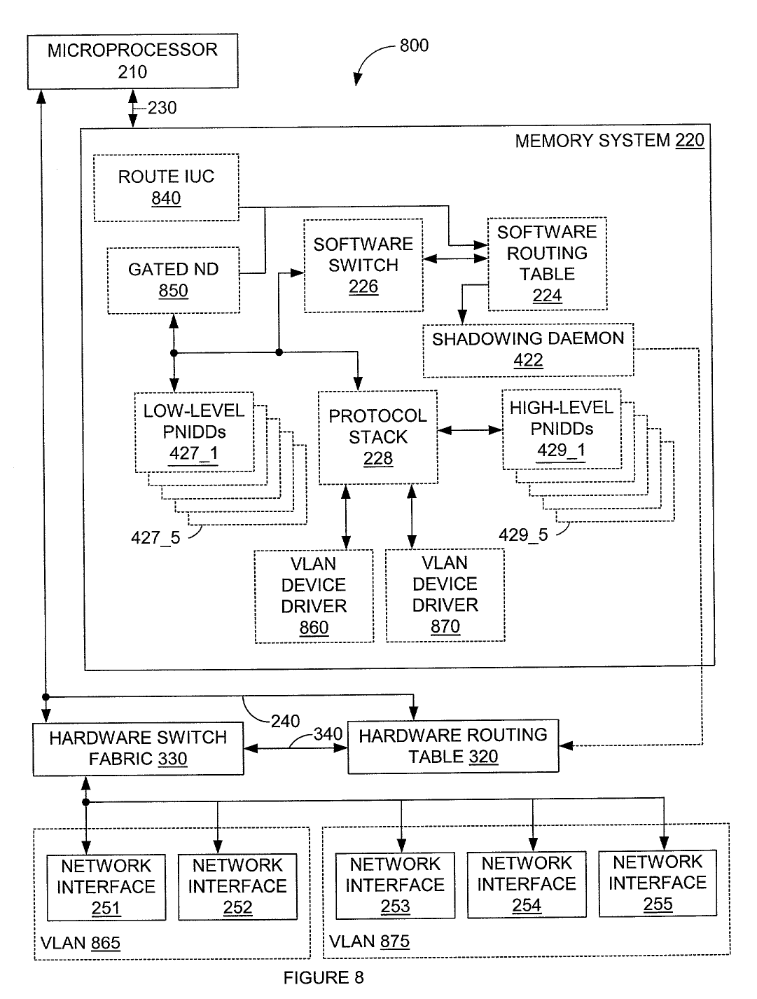

FIG. 8 illustrates a network controller 800 in accordance with one embodiment of the present invention. Network controller 800 uses both VLAN device drivers and pseudo network interface device drivers. Network controller 800 uses the Linux operating system (not shown), which is loaded in memory system 220. The Linux operating system includes protocol stack 228, software routing table 224, and software switch 226. Network software is typically open-source software delivered with the Linux operating system, as part of a complete software distribution. As shown in FIG. 8, examples of the network software include “route” interactive user command (ROUTE IUC 840) and “gated” networking daemon (GATED ND 850). In accordance with the operation of Linux, low-level pseudo network interface drivers 427_1-427_5 could be named “zre0”, “zre1”, . . . “zre4” respectively. The low-level pseudo network interface device drivers are used by the network software as described above to send and receive data packets on network interfaces 251-255 as desired. In general a shell command can be used to create VLAN device driver 860 and 870, which can be used by the network software to send and receive data packets to and from VLAN 865 and 875 as desired. In accordance with the operation of Linux, VLAN device drivers 860 and 870 could be named “zhp0” and “zhp1”, respectively.

Gated networking daemon 850 sends and receives data packets to and from the network in accordance with the rules of a standard routing protocol, the purpose of which is to automatically determine the correct contents of software routing table 224. In general gated networking daemon 850 is software that operates the layer 3 protocol and thus would modify the layer 3 portion of software routing table 224. Some embodiments of the present invention may have separate routing tables for each networking layer. Gated networking daemon 850 can utilize VLAN device drivers 860 and 870 to identify the origin VLAN (i.e. VLAN 865 or VLAN 875) of each data packet. When new routing information is determined, gated networking daemon 850 makes modifications to software routing table 224. The change is sensed by shadowing daemon 422, which then takes action to program hardware routing table 320 appropriately. An operator can use route interactive user command 840 to make manual changes to software routing table 224. When changes are made manually by the operator, shadowing daemon 422 senses the change and makes the appropriate changes to hardware routing table 320. Thus, the source of the changes in software routing table 224 are not significant to the operation of shadowing daemon 422.

In the above-described manner, a high speed network controller in accordance with the present invention combines the speed of hardware switch fabrics with the flexibility and ease of use of software switches. Specifically, a shadowing daemon updates a hardware routing table with information from or destined for a software routing table. By using pseudo network interface device drivers in place of network interface device drivers, network software designed for software switches can be used with hardware switch fabrics without modification.

The various embodiments of the structures and methods of this invention that are described above are illustrative only of the principles of this invention and are not intended to limit the scope of the invention to the particular embodiments described. For example, in view of this disclosure, those skilled in the art can define other network controllers, hardware switch fabrics, software switches, hardware routing tables, software routing tables, shadowing daemons, snooping daemons, network interface device drivers, pseudo network interface device drivers, VLAN device drivers, protocol stacks, protocol stack ports, network interface ports, network software ports, hardware switch fabric ports, network interfaces, microprocessors, network operating systems, memory systems, and so forth, and use these alternative features to create a method or system according to the principles of this invention. Thus, the invention is limited only by the following claims.

1. A method of configuring a hardware switch fabric having a hardware routing table, the method comprising:
maintaining a software routing table;
detecting a change in the software routing table; and
copying the change to the hardware routing table.

2. The method of claim 1, further comprising translating the change in the software routing table into a hardware routing table format.

3. The method of claim 1, wherein the maintaining a software routing table comprises operating network software that controls and updates the software routing table.

4. The method of claim 3, wherein the network software is gated.

5. The method of claim 4, wherein the network software is routed.

6. A method of configuring a hardware switch fabric having a hardware routing table, the method comprising:
maintaining a software routing table; and
detecting an instruction to change the software routing table; and
applying the instruction to the hardware routing table.

7. The method of claim 6, further comprising translating the instruction into a hardware routing table format.

8. The method of claim 6, wherein the maintaining a software routing table comprises operating network software that controls and updates the software routing table.

9. The method of claim 8, wherein the network software is gated.

10. The method of claim 6, wherein the network software is routed.

11. A network controller comprising:
network software configured to update a software routing table;
a shadowing daemon coupled to the software routing table; and
a hardware routing table coupled to the shadowing daemon, wherein the shadowing daemon is configured to copy changes in the software routing table to the hardware routing table.

12. The network controller of claim 11, further comprising a memory system containing the network software, the shadowing daemon and the software routing table.

13. The network controller of claim 12, further comprising a microprocessor coupled to the memory system.

14. The network controller of claim 13, wherein the microprocessor and memory system are configured to use a network operating system.

15. The network controller of claim 14, wherein the network operating system is Linux.

16. The network controller of claim 11, wherein the network software is gated.

17. The network controller of claim 11, wherein the network software is routed.

18. The network controller of claim 11, further comprising a hardware switch fabric coupled to and configured to use the hardware routing table.

19. The network controller of claim 18, further comprising a plurality of network interfaces coupled to the hardware switch fabric.

20. A network controller comprising:
network software configured to update a software routing table;
a snooping daemon coupled to the software routing table; and
a hardware routing table coupled to the shadowing daemon, wherein the snooping daemon is configured to detect an instruction to change the software routing table and to applying the instruction to the hardware routing table.

21. The network controller of claim 20, further comprising a memory system containing the network software, the snooping daemon and the software routing table.

22. The network controller of claim 21, further comprising a microprocessor coupled to the memory system.

23. The network controller of claim 22, wherein the microprocessor and memory system are configured to use a network operating system.

24. A system for configuring a hardware switch fabric having a hardware routing table, the system comprising:
means for maintaining a software routing table;
means for detecting a change in the software routing table; and
means for copying the change to the hardware routing table.

25. The system of claim 24, further comprising means for translating the change in the software routing table into a hardware routing table format.

26. A system for configuring a hardware switch fabric having a hardware routing table, the system comprising:
means for maintaining a software routing table; and
means for detecting an instruction to change the software routing table; and
means for applying the instruction to the hardware routing table.

27. The system of claim 26, further comprising means for translating the instruction into a hardware routing table format.
